(19) United States
(12) Patent Application Publication
(10) Pub. No.: US 2013/0116353 A1
(43) Pub. Date: May 9, 2013

(54) COMPOSITION FOR POROUS PLASTICS FOR INTAKE HOUSINGS

(71) Applicants: Young Hak Jang, Seoul (KR); Je Hui Jun, Suwon (KR); Hee-Sok Chang, Uijeongbu (KR)

(72) Inventors: Young Hak Jang, Seoul (KR); Je Hui Jun, Suwon (KR); Hee-Sok Chang, Uijeongbu (KR)

(73) Assignees: KOPLA CO., LTD., Siheung (KR); HYUNDAI MOTOR COMPANY, Seoul (KR)

(21) Appl. No.: 13/363,749

(22) Filed: Feb. 1, 2012

(30) Foreign Application Priority Data
Nov. 4, 2011 (KR) 10-2011-0114358

(51) Int. Cl. C08L 77/00; C08J 9/04; C08K 3/36; C08K 7/14; C08K 7/06; C08K 3/34; C08K 7/28

(52) U.S. Cl. 521/91; 521/134; 521/92; 521/94

(57) ABSTRACT

Disclosed is a porous plastic resin composition including a polypropylene-based resin, a polyamide-based resin, or an alloy resin made by alloying the two resins to each other with a compatibilizer, reinforced with an inorganic filler or a short glass fiber, and further including a porous inorganic filler and a special inorganic low blowing agent. When the disclosed porous plastic resin composition is used to make an intake housing part, it reduces the weight and cost of an automobile intake housing part.

### CROSS-REFERENCE TO RELATED APPLICATION

This application claims under 35 U.S.C. §119(a) the benefit of Korean Patent Application No. 10-2011-0114358 filed on Nov. 4, 2011, the entire contents of which are incorporated herein by reference.

### BACKGROUND

(a) Technical Field

The present invention relates to a porous plastic resin composition for making strong, lightweight automobile components, and more particularly, intake housings.

(b) Background Art

In the conventional art, automobile intake housings are typically made of a plastic material including a polypropylene resin, which is mixed with talc as an inorganic filler in appropriate amounts according to the desired use, or is reinforced with short glass fiber. For automobiles with higher vibration and noise levels, a polyamide 6 resin is typically mixed together with short glass fiber reinforcement material to make intake housings. Also, if higher levels of reinforcement are required, a polyamide 66 resin is mixed together with short glass fiber reinforcement material for automobiles that require higher levels of reinforcement within their plastic components.

Conventional art attempts to use other types of materials, such as composite resins and reinforced resins, to make intake housing were disadvantageous because they decreased production efficiency and quality control, and increased both the weight of the components, and their cost of a production. This has made it difficult to reduce automobile production cost and improve fuel efficiency. For other parts made with a composite resin, a portion of the talc was replaced with bubble glass. Disadvantageously, this was not able to achieve a specific gravity reducing effect of 10% or more due to deterioration of the material; additionally, it was also associated with an increased cost of production. These materials were not well suited for absorbing/isolating vibration and noise.

Technologies such as a gas-assisted injection process or a supercritical fluid (SCF) injection process (Mucell) were developed and tested as processing methods for introducing porosity to a material, but unfortunately these technologies are cost prohibitive because they require a dedicated injection machine and facility. Accordingly, there is an urgent need to develop a porous plastic material with a low specific gravity, a low production cost, and improved vibration/noise absorbing and isolating functions, which does not require an additional investment in production infrastructure.

The above information disclosed in this Background section is only for enhancement of understanding of the background of the invention.

### SUMMARY OF THE DISCLOSURE

The present invention provides a porous plastic resin composition having improved vibration/noise absorbing and isolating functions, in which the specific gravity is reduced by 15% or more relative to the conventional art, as a result of increased porosity. According to the invention, a porous plastic resin includes a polypropylene-based resin, a polyamide-based resin, or an alloy resin made by alloying the two resins to each other with a compatibilizer. The porous plastic resin is reinforced with an inorganic filler, or a short glass fiber, and further includes a porous inorganic filler and a special inorganic low blowing agent.

The present invention provides a porous plastic composition for intake housings, which includes (A) 70-80 wt % of a polypropylene resin, polyamide 6, or an alloy resin obtained by alloying polyamide 6 to polypropylene with anhydrous maleinized polypropylene; (B) 4-10 wt % of an inorganic filler; (C) 4-10 wt % of an inorganic reinforcing material; (D) 4-10 wt % of hollow microspheres; (E) 4-10 wt % of porous microparticles; and (F) 1-5 wt % of a blowing agent.

Another object of the present invention is to provide a part for intake housings, which is made of the disclosed porous plastic composition.

In another aspect, there is provided a porous plastic composition for intake housings, which includes (A) 70-80 wt % of a polypropylene resin, polyamide 6, or an alloy resin obtained by alloying polyamide 6 to polypropylene with anhydrous maleinized polypropylene; (B) 4-10 wt % of an inorganic filler; (C) 4-10 wt % of an inorganic reinforcing material; (D) 4-10 wt % of hollow microspheres; (E) 4-10 wt % of porous microparticles; and (F) 1-5 wt % of a blowing agent.

The composition of the invention provides numerous advantages. For example, intake housings made of the composition will overcome the existing difficulties in the conventional art by reducing the weight and cost of an automobile intake housing part. As another example, the composition of the invention is suitable for other internal parts, thereby maximizing the fuel efficiency improvement of an automobile. Furthermore, the composition of the invention can also help to reduce the weight ship and airplane components as well, thereby increasing the fuel efficiency of ships and airplanes as well.

Other aspects and exemplary embodiments of the invention are discussed infra.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9.

The present invention provides a porous plastic composition for intake housings, which includes (A) 70-80 wt % of a polypropylene resin, polyamide 6, or an alloy resin obtained by alloying polyamide 6 to polypropylene with anhydrous maleinized polypropylene; (B) 4-10 wt % of an inorganic filler; (C) 4-10 wt % of an inorganic reinforcing material; (D) 4-10 wt % of hollow microspheres; (E) 4-10 wt % of porous microparticles; and (F) 1-5 wt % of a blowing agent.

According to an exemplary embodiment, the polypropylene-based resin may include a homopolymer, a random copolymer, or a block copolymer.

The polyamide-based resin may include polyamide6, polyamide 66, or a polyamide 6,66 copolymer.

The polypropylene-based resin may be alloyed to the polyamide-based resin with anhydrous maleinized polypropylene as a reactive compatibilizer.

An inorganic filler may include talc, wollastonite, or calcium carbonate, alone or in combination; additionally, a short glass fiber may be mixed therewith.

A hollow inorganic filler may include bubble glass or balloon glass, alone or in combination.

A porous inorganic filler may include ash, silica, or fired ceramic, alone or in combination. A special microcellular blowing agent may include a sodium bicarbonate-based inorganic blowing agent, or an amide-based organic blowing agent, alone or in combination.

As described herein, the porous plastic composition has a specific gravity that may be reduced by 15% or more with respect to the total weight, thereby greatly improving the ability of material made from the composition to isolate sound from vibration, noise, etc.

According to an exemplary embodiment, a polypropylene-based resin selected from the group including a homopolymer, a random copolymer, a block copolymer, or a mixture thereof; a polyamide-based resin selected from the group including polyamide6, polyamide66, a polyamide6, 66 copolymer or a mixture thereof; or an alloy resin obtained by alloying the polypropylene-based resin to the polyamide-based resin with anhydrous maleinized polypropylene as a reactive compatibilizer is used in an amount of 75-80 wt %, an inorganic filler selected from the group including talc, wollastonite, calcium carbonate, clay, or a mixture thereof is used in an amount of 5-10 wt %, a short glass fiber as an inorganic reinforcement material is used in an amount of 10-15 wt %, a hollow inorganic filler selected from the group including bubble glass(3M), balloon glass (onyxcell), or a mixture thereof is used in an amount of 5-10 wt %, a porous inorganic filler selected from the group including ash, silica, fired ceramic, or a mixture thereof is used in an amount of 5-10 wt %, and a special microcellular blowing agent selected from the group including a sodium bicarbonate-based inorganic blowing agent, an amide-based organic blowing agent, or a mixture thereof is used in an amount of 1-5 wt %.

More specifically, a block copolymer having a melt index in a range of 80(g/10 min) to 120(g/10 min), that is, ultra high-flowability polypropylene (Honam) is preferably used in an amount of 75-80 wt % as a polypropylene-based resin as a matrix material, since a melt index of less than 80 lowers the specific gravity reducing effect is lowered due to damage to the hollow filler and the porous filler. Additionally, a random copolymer or a homopolymer with ultra high-flowability may be used. It is also contemplated that ultra high-flowability polyamide6 resin (KP Chemtech) having a melt index in a range of 80(g/10 min) to 120(g/10 min) is preferably used in an amount of 75-80 wt % as a polyamide-based resin matrix material, since a melt index of less than 80, causes the same problem described above for the polypropylene-based resin. It is further contemplated that the composition may include, but is not limited to, polyamide66, or a copolymer of polyamide6 and polyamide 66, with ultra high-flowability.

As an inorganic filler, talc (coach) with a mesh of 300 or more is preferably used in an amount of 5-10 wt %. When the mesh of talc is less than 300, the elongation and the impact strength are lowered. Furthermore, when the talk is used in an amount of 10 wt % or more, the property balance is deteriorated, and the specific gravity reducing effect is significantly lowered. It is also contemplated that wollastonite, clay, and calcium carbonate, with a mesh of 300 or more, may be used.

Instead of using the inorganic filler as an inorganic reinforcement material, a short glass fiber (Owens, diameter: 9-11 μm, length: 3-4 mm) adhered with a cross-linking agent may be preferably used in an amount of 10-15 wt %, and the cross-linking agent is preferably amine-based or epoxy-based. When a short glass fiber not applied with a cross-linking agent, the tension and the impact strength may be lowered. Also, a short carbon fiber with the same size as that of the short glass fiber may be used, and an inorganic filler may be mixed with the short glass fiber.

In one embodiment, bubble glass (3M) with a mechanical pressure-breaking strength of 300 kgf/cm² or more, and a diameter of less than 50 μm is preferably used in an amount of 5-10 wt %. When the strength is less than 300 kgf/cm², the filler is destroyed during the extrusion and injection processes, thereby significantly lowering the specific gravity reducing effect. Also, when the diameter is 50 μm or more, the elongation and the impact strength are lowered. Also, balloon glass (onyxcell) with a compressive strength of 300 kgf/cm² or more, and a diameter of less than 50 μm may be used or mixed with the bubble glass. The porous inorganic filler may include natural ash (Sam Gong fine chemicals) with an average particle size of less than 40 μm in an amount of 5-10 wt %. When the size is 40 μm or more, mechanical properties such as elongation and impact strength may be lowered. Also, as similar materials, silica, or fired ceramic, with a particle size of less than 40 μm may be used alone or in combination.

As the special microcellular blowing agent (the last one of the above mentioned main components), a sodium bicarbonate-based inorganic blowing agent (Kum-Yang) with a foaming gas amount of 15-45 ml/gr is preferably used in an amount of 1-5 wt %. When the agent is used in an amount of 5 wt % or more, the mechanical strength may be lowered due to deformation of appearance. Also, as the organic blowing agent, azodicarbonamide may be used alone or in combination with the agent.

The porous plastic resin composition for automobile intake housings includes an ultra high-flowability thermoplastic resin with a high melt index, the highest processibility, and the highest balance of a mechanical strength and a material cost such as ultra high-flowability polypropylene (a polypropylene-based resin, a block copolymer), or ultra high-flowability polyamide6 (polyamide-based resin). Also, a polyamide propylene alloy resin obtained by alloying the two resins with anhydrous maleinized propylene as a reactive compatibilizer may be used as a matrix. In one embodiment, conventional inorganic filler and a conventional reinforcement material may be partly replaced with a hollow/porous light-weight filler, thereby reducing the specific gravity by 10% or more. It is further contemplated that a special inorganic microcellular blowing agent may be added thereto so as to reduce the total specific gravity by 15% or more. This gives porosity to the plastic product, thereby further improving the sound isolation against vibration and noise. According to one aspect, a heat stabilizer, primary and secondary antioxidants, internal/external lubricants, and a coloring master batch may be added to the composition as agents for the extrusion process and the injection process.

According to another aspect of the present invention, there is provided an automobile intake housing part made of the porous plastic composition of the invention.

According to a further aspect of the present invention, there is provided an automobile engine chassis made of the disclosed porous plastic composition.

According to a still further aspect of the present invention, there is provided an automobile interior part made of the porous plastic composition.

According to a yet further aspect of the present invention, there is provided an automobile exterior part made of the porous plastic composition.

### EXAMPLES

Hereinafter, the present invention will be described in more detail with reference to Examples. However, the following examples are not intended to limit the scope of the invention.

### Examples 1-6 and Comparative Examples 1-6

According to the compositions and amounts noted in Table 1 below, 3 matrix resins A, B, and C, an inorganic filler D1, and a reinforcing material D2 were combined with hollow/porous inorganic fillers and a microcellular blowing agent, and then subjected to an extrusion process in a two-axis extruder (35 mm) The matrix resin, additives, and the inorganic blowing agent were kneaded in a preliminary kneader for about 10 minutes, and introduced into a main inlet. An inorganic filler or a short glass fiber was introduced to one side of the two side supply devices (secondary inlet), and hollow/porous fillers were introduced into the other side supply device.

While the temperature of the extruder cylinder and the die was equal to or greater than a melting point (15) of a matrix resin, and the screw rotation speed was 350 rpm, strands were produced from a cooling water tank after melt-kneading. The strands were subjected to cooling, granulating, and selecting processes, and then finally dried in dehumidifying and drying devices at 100° C., for 3 hours or more.

TABLE 1

| | Index | | | | | | | | | | | |
|---|---|---|---|---|---|---|---|---|---|---|---|---|
| | Examples (unit %) | | | | | | Comparative Examples (unit %) | | | | | |
| Index | 1 | 2 | 3 | 4 | 5 | 6 | 1 | 2 | 3 | 4 | 5 | 6 |
| A | 80 | — | — | 75 | — | — | 80 | 70 | 70 | 75 | — | — |
| B | — | 80 | | — | 75 | — | — | — | — | — | 75 | 70 |
| C | — | — | 80 | — | — | 75 | — | — | — | — | — | — |
| D1 | 5 | 5 | 5 | — | — | — | 20 | 5 | 5 | 5 | — | — |
| D2 | — | — | — | 10 | 10 | 10 | — | — | — | | 15 | 30 |
| E | 5 | 5 | 5 | 5 | 5 | 5 | — | 15 | 5 | 5 | 5 | — |
| F | 5 | 5 | 5 | 5 | 5 | 5 | — | 5 | 15 | 5 | 5 | — |
| G | 5 | 5 | 5 | 5 | 5 | 5 | — | 5 | 5 | 10 | 5 | — |

A: polypropylene, block copolymer resin - Honam Petrochemical Corp (J945)
B: polyamide6, homopolymer resin - KPchemtech(RV 2.3)
C: polypropylene + anhydrous maleinized polypropylene + polyamide6(3:1:6)
D1: talc, inorganic filler 340mesh -coach
D2: short glass fiber(GF), inorganic reinforcing material - Owens corning
E: bubble glass(BG), hollow inorganic filler - 3M(S60HS)
F: ash, porous inorganic filler - Sam Gong fine chemicals
G: microcellular blowing agent, sodium bicarbonate-based inorganic blowing agent -
kumyang(HD20)

### TEST EXAMPLES

Test Example: Property Measurement and Sound Isolation Test

In order to measure mechanical properties and to test sound isolation on the resins prepared according to the compositions of Examples 1-6 and Comparative Examples 1-6, a test specimen was prepared in accordance with the experiment standard (ASTM) below, and measured by a standard test method. The results are noted in Table 2 below.

(1) Tensile Strength

In accordance with ASTM D 638 (Standard Test Method for Tensile Properties of Plastic), a test specimen for measurement was prepared, and a tensile strength and an elongation (elongation at break) were measured by using a universal testing machine (UTM).

(tensile strength [Pa]=maximum Load[N]/cross sectional area [m²[ of initial test sample

elongation(%)=increased length up to a break point/initial length)

(2) Flexural Strength

In accordance with ASTM D790 (Standard Test Method for Tensile Properties of Plastic), a test specimen for measurement was prepared, and a flexural strength and a flexural modulus were measured by using a UTM.

(3) Impact Strength

In accordance with ASTM D256 (Standard Test Method for Tensile Properties of Plastic), a test specimen for measurement was prepared, and an impact strength was measured by using Izod Impact Tester.

(4) Specific Gravity

In accordance with ASTM D792 (Standard Test Method for Tensile Properties of Plastic), a test specimen for measurement (weight: 200 g, area: less than 60×80×30 mm) was prepared, and a specific gravity was measured by using Electron Specific Gravity Tester.

(5) Sound Isolation Test

In the present invention, in the sound isolation test method, a sound absorptivity measurement using ASTM E1050-07 impedance tube was carried out so as to calculate a sound absorbing coefficient. The coefficient is defined by the following equation:

sound absorptivity α=1-reflected sound frequency/incident sound frequency (incident frequency: 100-5000 Hz, ⅓oct interval)

An average value of 3 test samples 1 (thickness 3.2 mm×diameter 98.8 mm), and an average value of 3 test samples 2 (thickness 3.2 mm×diameter 28.8 mm) were compared to a test sample as a replacement material. As a device for signal processing and measurement of a normal sound impedance, Symphonic 01 dB was used.

TABLE 2

| | | | | | Sound |
|---|---|---|---|---|---|
| | Property Characteristics | | | | Isolation |
| | | | impact | | (sound |
| | tensile | flexural | strength | specific | absorbing |
| Index | strength | strength | (kgf · cm/ | gravity | coeffi- |
| index | (kgf/cm²) | (kgf/cm²) | cm) | (g/cc) | cient) |
| Example 1 | 318 | 486 | 3.0 | 0.858 | 0.040 |
| Example 2 | 645 | 1,075 | 4.7 | 1.045 | 0.051 |
| Example 3 | 523 | 788 | 3.9 | 0.953 | 0.044 |
| Example 4 | 615 | 918 | 4.1 | 0.875 | 0.042 |
| Example 5 | 997 | 1,250 | 4.8 | 1.079 | 0.053 |
| Example 6 | 742 | 1,064 | 4.3 | 0.977 | 0.047 |
| Comparative | 308 | 410 | 3.1 | 1.061 | 0.011 |
| Example 1 | | | | | |
| Comparative | 292 | 405 | 2.8 | 0.884 | 0.046 |
| Example 2 | | | | | |
| Comparative | 298 | 401 | 2.6 | 0.891 | 0.051 |
| Example 3 | | | | | |
| Comparative | 268 | 386 | 2.1 | 0.846 | 0.054 |
| Example 4 | | | | | |
| Comparative | 1,105 | 1,720 | 6.2 | 1.113 | 0.039 |
| Example 5 | | | | | |
| Comparative | 1,665 | 2,250 | 11.5 | 1.362 | 0.022 |
| Example 6 | | | | | |

As noted in Table 2, as compared to the mechanical strength of a conventionally used material (Comparative Example 1=PP/talc 20 wt %, Comparative Example6=PA6/GF 30 wt %), the mechanical strength of polypropylene-based materials (Examples 1, and 4) was similar or higher, and the mechanical strength of polyamide-based materials (Examples 2 and 5) was slightly lower. The resins from Examples showed a high strength, which exceeds an actual product's polypropylene-based composite resin standard requirement for sound isolation improvement. Thus, it was determined that the novel materials of the present invention are usable in view of mechanical strength. In the present invention, main characteristics were improved in such a manner that a specific gravity was reduced by 15%, and sound isolation (impedance tube method, sound absorptivity a) was increased as compared to a conventional material. Also, Examples were advantageous in view of specific gravity reduction and cost reduction in order of Example 1 and 4, Examples 3 and 6, and Examples 2 and 5, and advantageous in view of sound isolation and mechanical strength in the reverse order.

Accordingly, it can be found that when the inventive porous plastic resin composition for automobile intake housings is used, it is possible to achieve a specific gravity reduction by 15%, and a significant improvement of sound isolation, as compared to a conventional art material.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A porous plastic composition for intake housings, comprising:
(A) 70-80 wt % of a polypropylene resin, polyamide 6, or an alloy resin obtained by alloying polyamide 6 to polypropylene with anhydrous maleinized polypropylene;
(B) 4-10 wt % of an inorganic filler;
(C) 4-10 wt % of an inorganic reinforcing material;
(D) 4-10 wt % of a hollow microsphere;
(E) 4-10 wt % of a porous microparticle; and
(F) 1-5 wt % of a blowing agent.

2. The porous plastic composition of claim 1, wherein the inorganic filler is selected from talc, wollastonite, clay calcium carbonate, mica, or a mixture thereof.

3. The porous plastic composition of claim 1, wherein the inorganic reinforcing material is selected from short glass fibers, long glass fibers, short carbon fibers, long carbon fibers, or a mixture thereof.

4. The porous plastic composition of claim 1, wherein the hollow microspheres are selected from short fibers of bubble glass, long fibers of bubble glass, short fibers of balloon glass, long fibers of balloon glass, or a mixture thereof.

5. The porous plastic composition of claim 1, wherein the porous microparticles are selected from ash, silica, or a mixture thereof.

6. The porous plastic composition of claim 1, wherein the blowing agent is selected from a sodium bicarbonate-based inorganic blowing agent, an amide-based organic blowing agent, or a mixture thereof.

7. The porous plastic composition of claim 1, wherein the polypropylene resin is selected from the group consisting of a propylene homopolymer, a propylene block copolymer, and a propylene random copolymer.

8. The porous plastic composition of claim 7, wherein the polyamide 6 resin is a homopolymer.

9. The porous plastic composition of claim 1, wherein the alloy resin comprises 20-40wt % of the polypropylene resin, 50-70wt % of the polyamide 6 resin, and 5-15wt % of the anhydrous maleinized polypropylene as a compatibilizer.

10. The composition of 2, wherein the inorganic filler has a particle size of 300 mesh or more.

11. The composition of claim 3, wherein the short glass fibers, the long glass fibers, the short carbon fibers, and the long carbon fibers have a diameter of 9-11 μm, and a length of 3-12 mm.

12. The composition of claim 4, wherein the bubble glass and the balloon glass have a diameter of 5-50 μm, and a crush strength of 300 kgf/cm².

13. The composition of claim 5, wherein the natural ash has an average particle size of 5-40 μm, and the silica has an average particle size of 5-50 μm.

14. The composition of claim 6, wherein the sodium bicarbonate-based inorganic blowing agent has a foaming gas amount of 15-45 ml/gr, and the amide-based organic blowing agent has a foaming gas amount of 30-60 ml/gr.

15. An automobile intake housing part made of the porous plastic composition of claim 1.

16. An automobile engine chassis made of the porous plastic composition of claim 1.

17. An automobile interior part made of the porous plastic composition of claim 1.

18. An automobile exterior part made of the porous plastic composition of claim 1.
